(19) United States
(12) Patent Application Publication
(10) Pub. No.: US 2023/0171327 A1
(43) Pub. Date: Jun. 1, 2023

(54) MEDIA DISTRIBUTION TRACKING SYSTEM

(71) Applicant: PALBASSADOR OY, Kiiminki (FI)

(72) Inventor: Eeva LÄHETKANGAS, Kiiminki (FI)

(21) Appl. No.: 17/906,621

(22) PCT Filed: Mar. 18, 2021
(86) PCT No.: PCT/FI2021/050193

§ 371 Date: Sep. 18, 2022

(30) Foreign Application Priority Data
Mar. 19, 2020 (FI) 20205281

(51) Int. Cl. H04L 67/50; G06Q 50/00

(52) U.S. Cl. CPC H04L 67/535; G06Q 50/01

(57) ABSTRACT

The present document discloses a solution for tracking distribution of media content. According to an aspect, a computer-implemented method for tracking distribution of media content comprises: storing, in a server computer, a first user account of a first user and a second user account of a second user; associating a media file with information linking the first user account with a vendor; detecting modification of the media file by the second user and, in response to said detecting, associating a modified media file with information linking the second user account with the vendor, the modified media file resulting from said modification; detecting an action linked to the modified media file and to the vendor; and in response to said detecting the action, updating at least one parameter of at least one of the first user account and the second user account.

### TECHNICAL FIELD

Embodiments of the invention described herein relate to tracking distribution of media content via computer networks.

### TECHNICAL BACKGROUND

Social networks have become more digital, and people share their thoughts, comments, and media content via various media applications. The media content refers to images, video, voice records, etc. Tracking distribution of the media content via the networks may be advantageous.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

### BRIEF DESCRIPTION OF DRAWINGS

In the following the invention will be described in greater detail by means of preferred embodiments with reference to the accompanying drawings, in which

FIG. 1 is illustrates a computer environment to which embodiments may be applied;

FIG. 2 illustrates a process for tracking distribution of a media file according to an embodiment;

FIGS. 3 to 6 illustrate signalling diagrams of various processes for tracking distribution and modification of the media file;

FIG. 7 illustrates a distribution tree for a media file;

FIGS. 8 to 10 illustrate signalling diagrams of various processes for tracking distribution and modification of the media file according to other embodiments; and

FIG. 11 illustrates a block diagram of an apparatus according to an embodiment.

### DETAILED DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

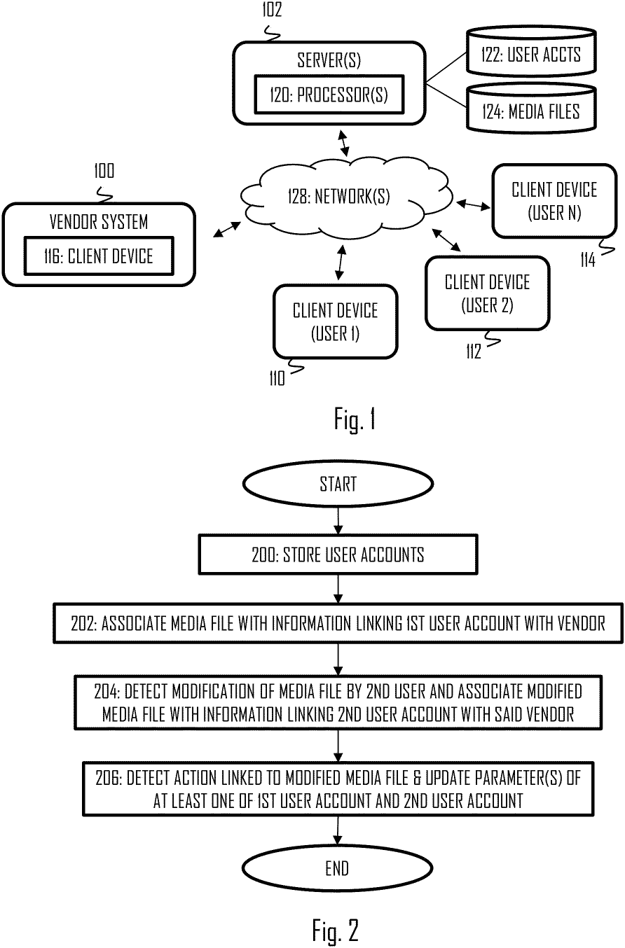

FIG. 1 illustrates a computer system to which some embodiments of the invention may be applied. Referring to FIG. 1, the system may comprise at least one server computer 102 accessible to various client devices and storing one or more databases used in the described embodiments. The server computer may manage a user account database 122 storing user accounts of various users of the system. A user account may define credentials of a user, personal characteristics of the user (such as gender, age, personal preferences) and various parameters of the user (access rights, gained vouchers, balance of account). The server computer may further manage a media file database 124 storing information on media files tracked according to embodiments described below. The server computer may comprise one or more processors 120 or processing circuitries configured to carry out communications with the client devices and the management of the databases, including adding new information to the databases, modifying or updating information stored in the databases, and deletion of information from the databases.

The server computer 102 may be accessible by the client devices via one or more computer networks 128, including the Internet. The networks 128 may further comprise wireless and/or wired networks, e.g. IEEE 802.11-based networks (WiFi), cellular communication networks (long-term evolution (LTE) or LTE-Advanced, 5G, etc.), ethernet. The connections with between the server computer and the client devices may be realized via transport control protocol over internet protocol (TCP-IP), as known in the art. Other means of forming the connection may, however, be employed.

The client devices 110, 112, 114 in FIG. 1 may be personal user devices carried by respective users 1 to N. The client devices may include mobile phones or other smart devices, tablet computers, etc. The client devices may have capability of executing computer program applications for communicating and processing media files such as images, video, and audio files. One of the computer program applications may be designed for tracking the media files, as described below.

Furthermore, a vendor system 100 is illustrated in FIG. 1. The vendor system 100 may represent a vendor of products or services. The vendor system may also include a client device 116. The client devices 110 to 116 may store and execute a dedicated computer program application that is configured to access the server computer 102, to register a user account in the server computer, and to store information on the user account. The dedicated computer program application may be the above-described application for tracking the media files. The computer program application in the vendor’s client device 116 may differ from the computer program application in the users’ client devices 110 to 114. For example, the computer program application in the client device 116 may be configured to execute functions unique to the vendor devices, e.g. cashier functions and/or other functions described below. The client devices and the server computer may be configured to execute the embodiments described below.

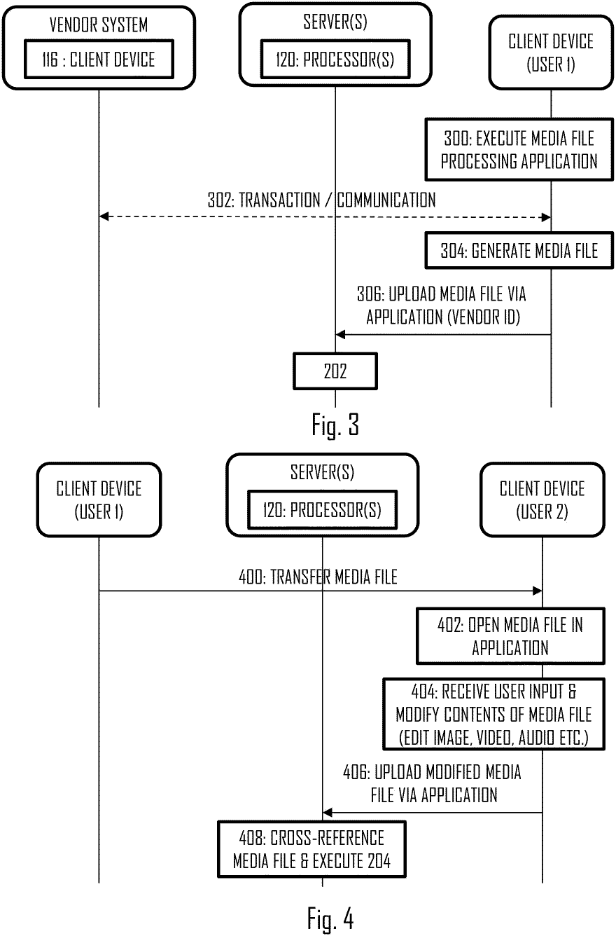

Referring to FIG. 2, let us describe a computer-implemented method for tracking distribution of media content. The method comprises: storing (block 200), in a server computer 102, a first user account of a first user and a second user account of a second user; associating (block 202) a media file with information linking the first user account with a vendor; detecting (block 204) modification performed by the second user on the media file and, in response to said detecting, associating a modified media file with information linking the second user account with the vendor, the modified media file resulting from said modification; detecting (block 206) an action linked to the modified media file and to the vendor and, in response to said detecting the action, updating (block 206) at least one parameter of at least one of the first user account and the second user account.

In an embodiment, the method of FIG. 2 is executed by the server computer 102. In another embodiment, the method comprises steps executed by the server computer 102 and steps executed by one or more client devices 110 to 116.

The media content represented by the media file may be linked to the vendor. In some embodiments, the media file may contain information on a product or a service provided by the vendor. When the media file is an image file or a video file, it may include an image or video of a product provided by the vendor. It may also contain textual information. When the media file is an audio file, the audio content may describe the product or the service provided by the vendor.

In an embodiment, the action is a transaction, e.g. an electronic purchase. In another embodiment, the action is another event, e.g. the user registering into a certain server computer or another instance.

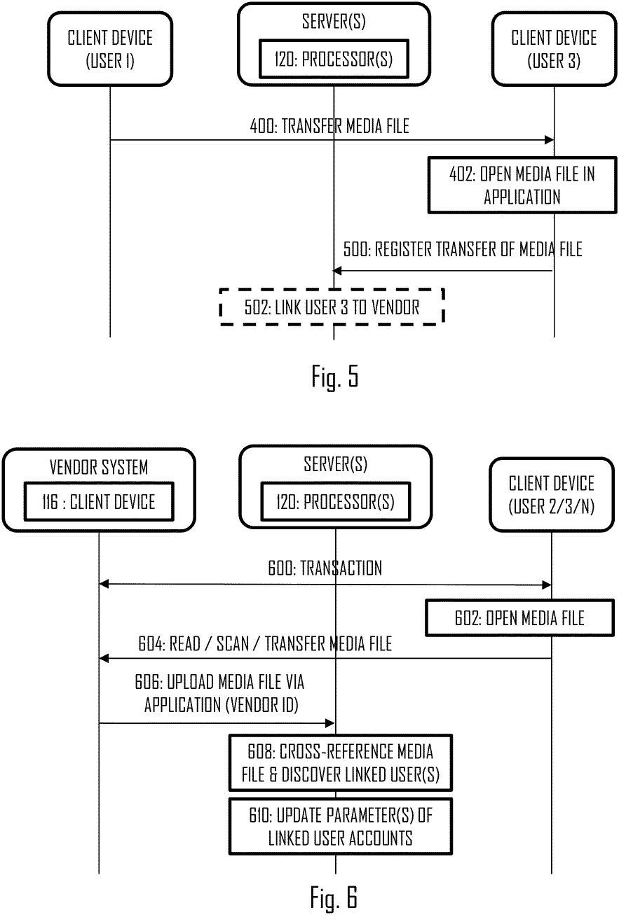

Let us then describe distribution and tracking the media file according to some embodiments. FIG. 3 illustrates an embodiment where the media file is generated in the client device 110 of user 1. The context of generating the media file may be that the user has consumed a product or a service from the vendor and wishes to advertise the vendor within the user’s network. Referring to FIG. 3, the client device 110 may execute a computer program application for managing the media files (block 300), e.g. a media file processing application. The application may be linked to the server computer such that the application may store a uniform resource locator (URL) of the server computer 102 and access the user’s user account in the server computer. When the application is executed by the user 1 for the first time, the application may guide the user to register the user account in the server computer 102 and store the above-described information on the user 1 in the data base 122.

Optional step 302 may include a transaction or another type of communication performed between the vendor system 100 and the client device 110. The transaction may be mobile payment executed by using the client device. The communication may include transfer of the media file from the vendor system to the client device, or from a web site of the vendor or from another source of the vendor to the client device. In block 304, the media file is generated and stored in the client device 110. Block 304 may be responsive to reception of the media file in step 302, it may be responsive to operation of a camera or another recording device of the client device, or it may be responsive to the user generating the media file by using a media creation tool of the client device. An example of the media creation tool is an image editor or a video editor. Upon generating the media file, the user may operate the computer program application to link the media file to the vendor. The linking may include loading the media file into the application. Alternatively, the application may automatically analyse the media file and detect the vendor from semantic information in the media, on the basis of a location of the client device, etc. and propose linking the media file to the detected vendor. The application may publish a campaign provided by the vendor or indicate the vendor in another manner. The user 1 may operate a user interface of the application and link the media file with the vendor. In response to the user input, the application may control the client device to execute step 306 where the media file is uploaded to the server computer together with an identifier of the vendor. Because the media file is uploaded by using the application associated with the user account of user 1, the media file is then linked associated with both the vendor and user 1 in the server computer. The server computer may thus execute block 202, store the media file in the media file database as linked to the user 1’s user account and to the vendor’s user account. The server computer may also store corresponding linking information in the user accounts of user 1 and the vendor so that the user accounts store information on media files linked to the respective user accounts.

FIG. 4 illustrates an embodiment of block 204. Referring to FIG. 4, user 1 may distribute the media file within his/her social network by publishing the media file in a social media application and/or by transmitting the media file over a messaging application. In step 400, the media file or a copy of the media file is delivered from the client device 110 to the client device 112 of user 2, e.g. directly via a peer-to-peer connection, over a communication network, or via a server of the social media or messaging application. Another solution for delivering the media file to the client device 112 is scanning contents of the media file, e.g. by producing a hard copy of the media file and then scanning the hard copy. A similar media file processing application configured to track the media files and connect to the server computer 102 may be installed in the client device 112. The media file may be configured to open in the computer program application by default. The media file may have a specific filename extension, for example. In block 402, the media file is opened in the computer program application.

In block 404, the client device 112 receives a user input from the user to modify the media file. In particular, the user input may control the client device to modify the contents visible to the user, such as image data, video data, and/or audio data of the media file. In a case where the media file is the image, the user may operate the user interface to add visual elements to the image, such as text, pictures, clip art, etc., to highlight a desired part of the image, etc. In a case where the media file contains video data or audio data, the user may add voice or audio to the media file. Other conventional forms of editing the media file may equally be applied. Upon saving the edited/modified media file, the application may upload the modified media file to the server computer (block 406). Alternatively, the uploading may be responsive to the user 2 publishing/transmitting the media file to one or more other client devices, e.g. via a messaging application or in a social media application. Since the computer program application is inherently linked to the user account of user 2, information indicating user 2 is transferred to the server computer in connection with the modified media file in step 406. Upon receiving the modified media file, the server computer may analyse the data of the media file and correlate the data with data of media files stored in the media file database 124 in an attempt to find a media file correlating with the modified media file. Upon discovering a media file correlating with the modified media file with a correlation factor above a certain reliability threshold, the server computer may determine that the modified media file is a modified version of the discovered media file, e.g. the one received and stored in the process of FIG. 3. Then, the server computer may execute step 204 and update the databases with the following information: a link between the discovered media file and the modified media file; a link between the modified media file and user 2. Additionally, the server computer may store the modified media file in the media file database 124. Additionally, the server computer may store information linking the vendor to the modified media file. The storing may be subject to a check where the server computer first ensures that the vendor still has enabled the linking. For example, the vendor may define a certain time interval when the linking is possible, or the vendor may decide when the end the linking enablement. If the linking is disabled, the server may refrain from storing the linking information. Additionally, the server computer may store information indicating user 2 as a modifier of the media file.

In an embodiment modified from the embodiment of FIG. 4, upon executing block 402 the computer program application may upload the media file to the server computer, and the server computer performs the above-described correlation and database update procedures. Upon detecting, on the basis of the correlation, the correct, original media file corresponding to the uploaded media file, the server computer may download the original media file to the client device where the computer program application may decide or prompt the user to decide whether the modification is performed on the original media file or the generated media file. Downloading the original media file to the client device for the modification provides an improvement when the media file received in step 400 has been corrupted. Accordingly, further distribution of the corrupted media file can be prevented. In an embodiment, the modifications may be made to the media file stored in the server computer. For example, the user may operate the computer program application to input the modifications on a template formed by the media file received in step 400 or by the original media file downloaded from the server, and the computer program application may acquire data on the modifications. The computer program application may then upload the data on the modifications to the server without the media file, and the server computer may implement the modification on the media file stored on the server by using the data on the modifications. In the same instance, the server computer may detect the modification and store the information linking the user to the vendor. In another embodiment, the user may edit the original media file stored on the server directly according to software-as-a-service principles. The user may use the computer program application to access the original media file stored in the server and modify the original media file in the server by inputting the modifications to the computer program application. The computer program application may then deliver the inputs to the server computer that implements the modifications to the original media file and links the user to the vendor. Upon completing the modification, the modified media file may be downloaded to the client device so that the user may distribute it.

In an embodiment,, the server computer checks validity of the media file received in step 400. The client device may upload the media file to the server computer for the validation. Only after the media file has been validated by the server computer, the computer program application may enable the modification of the media file. Such a validity check may prevent fraudulent modification and distribution of the media file.

In an embodiment, block 408 comprises (or block 408 is replaced by) analysing a subset of the data of the received media file. For example, the modification of the media file may include adding a unique component of user 2 into the media file, and the analysis may include searching the media file for such a unique component. For example, each user may have stored a unique logo in his/her user account in the server computer. The modification in block 404 may include adding the unique logo into the media file in a visible form. Then, the analysis may include scanning the media file for unique logos and, upon detecting a logo, searching the user account database 122 for the detected unique logo. Upon finding the logo, the corresponding user may be identified on the basis of the user account database, and block 204 may be executed. A similar procedure may apply to other user-specific components added to the media file in block 404.

Some users receiving the media file may distribute the media file without modifying the media file. FIG. 5 illustrates an embodiment for tracking the media file in connection with such users (user 3 in this case). Referring to FIG. 5, the media file may be transferred and opened in the computer program application (steps 400, 402) in the above-described manner. In this embodiment, the computer program application managing the media file in the client device of user 3 may register the transfer of the media file in the server computer (step 500). Step 500 may be responsive to the client device of user 3 receiving the media file, saving the media file in the client device, or publishing/transmitting the media file forward to one or more other client devices, e.g. via a messaging or social media application. Step 500 may comprise uploading the media file to the server computer. Upon receiving the media file, the server computer may perform the above-describe correlation in order to discover the whether the media file has already been registered in the media file database. Upon discovering the correct media file, the server computer may update the media file in the media file database with a link to the user account of user 3. Similarly, the server computer may update the user account of user 3 with a link to the media file. In this manner, the server computer may track the distribution of the media file to/by users that have not edited the media file.

In an embodiment, the server computer stores also information whether or not the client devices have further distributed the media file or the modified media file. In this manner, the users may be categorized into those that have actively distributed the media file or its modification and to those users that have simply received the media file. The categorization may be used when updating the parameters, as described below.

In the above-described manner, the media file may be delivered to several client devices of various users 2 to N. Some of the client devices may have the media file processing application for tracking the media file installed but it is not necessary. Some client devices may simply receive the media file and open the media file in a conventional manner, e.g. via a media file viewer of an operating system of a client device. By using the above-described principles, the server computer also stores a tree-type map illustrating the routes via which the media file as well as its modifications have been distributed. In other words, the map illustrates in detail which user has distributed which version of the media file to which users.

In an embodiment, said detecting the (trans)action (in block 206) comprises receiving, from a client device 116 of the vendor, transaction data indicating the media file, and wherein the updating (in block 206) is responsive to the transaction data and at least one of the information linking the first user account with the vendor and the information linking the second user account with the vendor.

FIG. 6 illustrates an embodiment related to block 206. FIG. 6 is described in the context of a transaction, a purchase, but a similar procedure is directly applicable to other actions as well. One of the recipients of the media file (user 2, user 3, user N) may then visit the vendor and purchase, from the vendor, a product or a service related to the media file. A corresponding transaction may be made in step 600, e.g. via mobile payment or in another manner. In connection with the purchase, the user may open the media file with the computer program application of his/her client device (block 602) and deliver the media file to the vendor’s client device. The media file may be transferred via a communication link such as WiFi or Bluetooth® link, or it may be scanned by a scanner (e.g. camera) of the vendor’s client device 116 (step 604). Upon receiving the media file, the client device 116 may upload the media file to the server computer in step 606. The client device 116 may have a similar computer program application installed, but the vendor may be registered as a vendor in the respective user account. Therefore, certain functions that are disabled from customers (users 1, 2, 3, ... N) may be enabled for the vendors. Since the media file is transferred under the control of the computer program application, the vendor’s identifier is also delivered to the server computer.

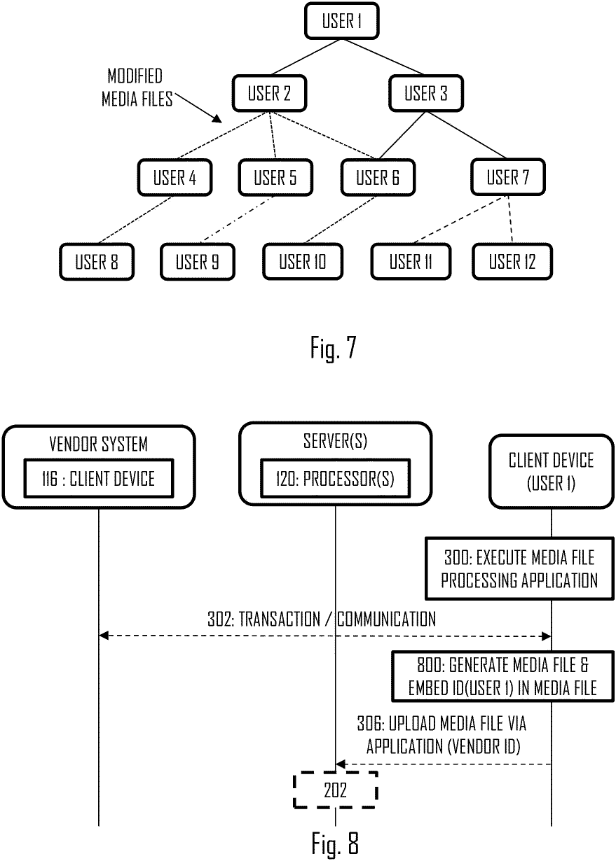

Upon receiving the media file from the client device 116, the server computer may correlate the received media file with media files in the media file database 124 in the above-described manner. Upon discovering from the media file database a media file providing the reliable correlation with the uploaded media file, the server computer may analyse the links of the discovered media file. Upon detecting that the uploaded media file is from a vendor, the server computer may trigger a function that checks the need for updating the parameter(s) of the user accounts linked to the media file. On the basis of the correlation and the discovery of the appropriate media file in the media file database, the server computer may perform the following functions. The server computer may follow the links stored in the media file database for the discovered media file in order to discover those users that have distributed the discovered media file and/or that have generated the discovered media as a modification of an earlier version of the media file. The server computer may also find the earlier version(s) of the media file and determine the users that have distributed the earlier version. In this manner, the server computer may determine those other users that have contributed to the distribution of the media file to the user that executed the transaction in step 600. FIG. 7 illustrates one distribution tree that may be stored in the server computer.

Instead of uploading the media file by the vendor’s client device 116, the transaction and the media file may be linked in another manner. For example, the client making the transaction may use his/her client device to upload the media file to the server computer together with an indication of the transaction. The indication of the transaction may alternatively be requested or provided by the vendor’s client device to confirm the transaction. Upon receiving the media file and detecting that the uploading relates to the transaction made by the user, the server computer may send a request for acknowledging the transaction to the vendor’s client device. Upon executing block 608 and receiving acknowledgment from the client device 116, the server computer may execute block 610.

In yet another embodiment, the media file is uploaded by the user’s or the vendor’s client device in step 606 and, as a response, the server computer performs block 608 or otherwise analyses the media file and discovers the user(s) linked to the media file. Before proceeding to block 610, the server computer may request the vendor’s client device to authorize the updating of the parameter(s) for the user(s) by transmitting an authorization request to the vendor’s client device 116. Upon receiving an acknowledgment of the authorization from the client device 116, the server computer may execute block 610.

In an embodiment, the client device 116 may acquire and upload a user identifier of the user that made the transaction in connection with the media file in step 606. The transmission of the user identifier may be used by the server computer to verify the distribution chain of the media file and ensure that the correct user(s) get their parameters updated. The user identifier may be transferred to the client device 116 in connection with step 604, for example, or entered manually to the client device 116.

In an embodiment, step 604 is replaced by manual transfer. For example, the client device 116 may have access to the server computer and access the media file database for media files linked to the vendor. A representative of the vendor may read/listen the media file from the user’s client device and select the corresponding medial file from a set of media files listed in the client device. Upon selecting the media file corresponding to the media file provided by the user, step 610 may be executed. In this case, block 606 may comprise uploading information on the selected media file, and block 608 may be omitted.

Referring to FIG. 7, the distribution may follow the embodiments described above. Accordingly, user 1 may distribute the original version of the media file to users 2 and 3. User 2 may modify the media file as described above in connection with FIG. 4 while user 3 does not modify the media file (see FIG. 5). User 2 then distributes the modified media file to users 4, 5, and 6, as illustrated by the dotted edges in FIG. 7. User 3 distributes the original version of the media file to users 6 and 7, which is further distributed by user 7 to users 11 and 12. Let us assume that user 7 has not installed the computer program application for tracking the distribution of the media files and, as a consequence, user 7 will not be registered in the server computer as a distributor of the media file. User 4 distributes the modified media file to user 8, while user 6 distributes the modified media file to user 10. User 5 makes a further modification to the modified media file, resulting in a further modified media file, and distributes the further modified media file to user 9, as illustrated by the dash-dotted edge in FIG. 7.

Now, assuming that the user making the transaction in step 600 is user 8, the server computer has stored the delivery route of the media file to user 8 (from user 1 via users 2 and 4) and that user 2 is stored as a modifier of the media file. As a consequence, the users 1, 2, and 4 are candidates for the update of the parameter of the user account. Any one or more of the above-described parameters of the users 1, 2, and/or 4 may thus be updated by the server computer. For example, at least the parameter(s) of the user 2 that modified the media file may be updated while another decision may be made for the user 4 that has only distributed the (modified) media file. The originator of the media file (user 1) may also receive the parameter update.

Let us then assume that the user making the transaction in step 600 is user 11, the server computer has stored the delivery route of the media file to user 3 (from user 1). Since user 7 has not been registered in association with the media file, the route from user 7 to user 11 is not detected. As a consequence, the users 1 and 3 are candidates for the update of the parameter of the user account. Any one or more of the above-described parameters of the user 1 and/or 3 may thus be updated by the server computer. If in this case the user 3 had modified the media file, at least the user 3 would receive the parameter update.

With respect to updating the parameters, various options are available depending on the configuration. The above-described classification of the users to an originator of the media file, a modifier of the media file, a distributor of the media file, and the recipient of the media file may be used. The recipient may be the user that carries out the transaction step 600 and provides the (modified) media file to the vendor. Different parameter updates may be carried out for different classes. For example, the modifier(s) of the media file in the route to the recipient and the originator of the media file may gain the parameter update but not the distributors. In another example, the modifier(s) gain(s) the parameter update but not the originator if there is at least a determined number of edges between the recipient and the originator. Yet another example is that the originator and a determined number of users (e.g. 2, 3, etc.) before the recipient may get the parameter update.

In the embodiments described above, the media file is tracked by using pattern recognition (correlation) between a media file uploaded to the server computer and the media files in the media file database. It may require a sophisticated pattern recognition algorithm using, for example, artificial intelligence to verify reliably the similarity between the original media file and the modification(s) of the media file. In another embodiment described next, said associating the media file (step 202) comprises embedding an identifier linking the first user account with the vendor into the media file, and wherein said associating the modified media file (step 204) comprises embedding an identifier linking the second user account with the vendor into the modified media file.

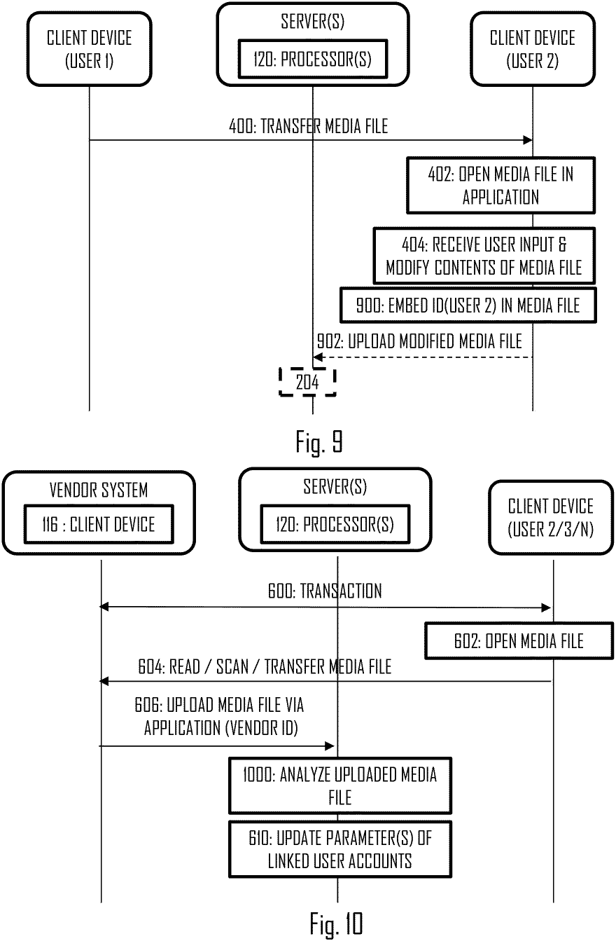

Referring to FIG. 8, steps 300 and 302 may be executed in the above-described manner. Upon generating the media file in the client device 110, the media file processing application may be used to embed the identifier of the user 1 into the media file. Additionally, an identifier of the vendor may be added to the media file by using the media file processing application. For example, the vendor may be listed in the media file processing application and the user may, through selection input via the user interface, select the vendor to be linked to the media file. In response to the selection input, the media file processing application may embed the vendor identifier into the media file as well.

In an embodiment, said embedding is carried out by encoding the identifier(s) into meta information of the media files such that the identifiers are invisible to a user playing back the media file. Such metadata may be added to an image file in exchangeable image file format (Exif), for example. MP3 files have ID3 tags that may be used to store metadata. Other media files provide similar formats for storing metadata that is not in ‘burnt’ into the media data such as the image data or audio data.

In an embodiment, each of the identifiers is a unique character string. Each user including the vendor may be provided with a unique character string that serves as a global identifier of the user/vendor. The string may be stored in the user account in the server computer and also in the media file processing application. In an embodiment where the character string is visible, step 604 may be replaced by the representative of the vendor reading the string from the media file and entering the string to the client device 116. The string is thus delivered to the server computer in step 606, and block 608 may be omitted.

In yet another embodiment, said embedding is carried out by encoding the identifier(s) into payload data of the media files. In such a case, the encoding may be such that the identifier(s) are visible to the user playing the media file, e.g. a personal and unique logo of a user. As the media file is modified by multiple users, the modified media file may include multiple visible such identifiers. In this embodiment, step 604 may be replaced by the representative of the vendor reading the string from the media file and entering the string to the client device 116. The string is thus delivered to the server computer in step 606, and block 608 may be omitted. In another embodiment, the identifiers are encoded into the payload data such that the identifiers are invisible but can be decoded by scanning the media file and decoding the scanned data with a decoder trained to detect the identifiers from the media data. In this embodiment, block 608 may be replaced by scanning the media file for identifiers and, upon detecting one or more identifiers, determining the user(s) associated with the one or more identifiers and performing block 610. In an embodiment, the media file may include visible and invisible identifiers, e.g. both an invisible and a visible identifier of one or more users. In this embodiment, both visible and invisible identifiers may be used by the server computer to verify the users that have distributed the (modified) media file. Encoding the identifiers into the payload data provides the advantage that the identifiers are maintained even in a case the media file is distributed by other means than as a digital copy. For example, a user may scan the media file from another user’s client device by using a camera or another image sensor, in which case the metadata is not necessarily transferred but the identifier(s) encoded into the image/video/audio data may be transferred. On the other hand, identifiers visible to a user are more susceptible to manipulation. Therefore, invisible identifiers may improve the reliability because they are less susceptible. In an embodiment where the media files are images, and said embedding is carried out by encoding the identifiers into image data of the images.

Referring back to FIG. 4, the embedding may be carried out in response to the user uploading the modified media file in step 406 and the server computer detecting the modification in block 408, e.g. on the basis of the correlation. In another embodiment described above in connection with FIG. 4, the embedding may be carried out upon the user accessing, via the computer program application of the user’s client device, the media file stored in the server computer and inputting the modifications to the media file. Upon detecting that the user modified the media file, the server computer may execute block 204 and embed the identifier to the media file. Thereafter, the media file with the identifier may be downloaded to the client device.

In an embodiment, the system employs concurrently both the embedded identifiers and the above-described pattern recognition for identifying and tracking the distribution of the media file.

In an embodiment, the modified media file is modified from a downloaded digital copy of the media file, as described above in connection with FIG. 4, for example.

Upon generating the media file, e.g. by capturing an image by using the client device or by receiving the media file via a communication circuitry of the client device, the media file processing application may embed the identifier of the user of the client device into the media file. In an embodiment, the media file processing application embeds into the media file also the class of the user having the identifier, e.g. one of the above-described classes. In case the user modifies the media file and saves the modified media file, the media file processing application may store the identifier together with an indication that the user associated with the identifier is a modifier of the media file. In connection with saving the modified media file and/or outputting the (modified) media file for distribution to other user(s), the media file processing application may upload the (modified) media file to the server computer (step 306) in the above-described manner. Instead of performing the above-described correlation, the server computer may read the information embedded into the media file and update the databases 122, 124 on the basis of the embedded information. For example, the server computer may store a link linking the user of the client device to the (modified) media file and, in case the modified media file is not yet stored in the media file database 124, the server computer may store the modified media file there. However, steps 306 and 202 are optional in this embodiment because the (modified) media file itself carries the relevant information. In fact, it can be seen that at least the client device executes block 202 in this embodiment by embedding user identifier into the media file.

FIG. 9 illustrates a corresponding modification to the procedure of FIG. 4. Referring to FIG. 9, steps 400 to 404 may be carried out in the above-described manner. Upon modifying the media file, e.g. as a response to saving the modified media file, the media file processing application may embed the identifier of the user of the client device 112 into the media file according to any one of the above-described embodiments. Thereafter, the modified media file may be uploaded to the server computer (step 902), as described above in connection with FIG. 8. The server computer may perform the same procedures as described above in connection with FIG. 8, i.e. analyse the modified media file to discover new association between the user 2 and the media file. In this case, the server computer may perform the above-described correlation in order to detect the original media file from which the modified media file originates and store the link between the media files. In another embodiment, each media file may be provided with a unique identifier, and the identifier may be embedded by the client devices processing the media file into the media file according to any one of the above-described embodiments. Each modified media file resulting from the original media file may also get a unique identifier that is embedded into the modified media file. Accordingly, a modified media file comprises embedded a unique identifier of the modified media file and unique identifiers of all previous versions of the modified media file. In this manner, the correlation-based detection may be omitted, and the media files will carry the links between the different versions of the media file.

Again, steps 902 and 204 may be optional in the embodiment of FIG. 9. In fact, the client device may perform step 204 by embedding the identifier of the user 2 into the modified media file.

FIG. 10 illustrates a corresponding modification to the procedure of FIG. 6. Steps 600 to 606 may be carried out in the above-described manner. Upon receiving the media file uploaded by the vendor’s client device, the server computer may analyse (block 1000) the uploaded media file and determine the users linked to the uploaded media file and carry out the updating of the parameter(s) in at least some of the users’ user accounts. All the relevant information may be contained in the media file, as described above. In this embodiment, the server computer may perform steps 202 and 204 in block 1000.

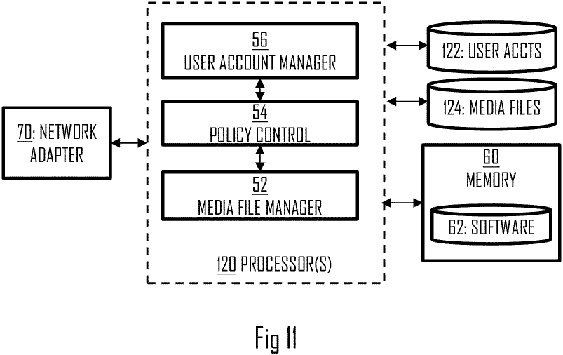

FIG. 11 illustrates an embodiment of an apparatus for the server computer executing the functions of the process of FIG. 3 or any one of its embodiments. The apparatus may be the server computer or one or more circuitries in the server computer. The apparatus may be an electronic device comprising electronic circuitries for realizing some embodiments of the present invention.

Referring to FIG. 11, the apparatus may comprise at least one processor 120 or a processing circuitry comprising modules 52 to 56 configured to execute various tasks of the server computer described above. The processor(s) 120 may have an access to a memory 60 storing one or more computer program products 62 configuring the operation of said processor(s) of the apparatus. The memory 60 may be implemented using any suitable data storage technology, such as semiconductor based memory devices, flash memory, magnetic memory devices and systems, optical memory devices and systems, fixed memory and removable memory. The processor(s) may further have access to the above-described databases 122, 124. The apparatus may further comprise a network adapter 70 providing the apparatus with computer networking capabilities with the client devices. The network adapter may support various higher layer or lower layer networking protocols such as the TCP/IP and Ethernet.

The processor(s) 120 may comprise a user account manager 56 configured to manage the user accounts and the parameters stored in the user accounts. A media file manager may maintain the media file database according to the embodiments described above. A policy controller 54 may perform the analysis of the media files and other information uploaded to the server computer by the client devices and decide the operations for updating the databases according to any one of the above-described embodiments. For example, the policy controller 54 may execute blocks 202 to 206 or any one of their embodiments and control the media file manager and/or the user account manager to update the respective databases accordingly.

According to an aspect, an apparatus for the client device comprises at least one processor and at least one memory storing one or more computer program products configuring the operation of said processor(s) of the apparatus to execute the above-described functions of any one of the client devices. The client device may be a smart phone, a tablet computer, or any applicable electronic consumer device provided with required processing and communication capabilities.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention. The processes or methods described in connection with FIGS. 2 to 10 may also be carried out in the form of one or more computer processes defined by one or more computer programs. A separate computer program may be provided in one or more apparatuses that execute functions of the processes described in connection with the Figures. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

It will be obvious to a person skilled in the art that, as the technology advances, the inventive concept can be implemented in various ways. The invention and its embodiments are not limited to the examples described above but may vary within the scope of the claims.

1. A computer-implemented method for tracking distribution of media content, comprising:
storing, in a server computer, a first user account of a first user and a second user account of a second user;
associating a media file with information linking the first user account with a vendor of products or services other than the media file;
detecting modification of the media file by the second user and, in response to said detecting, associating a modified media file with information linking the second user account with the vendor, the modified media file resulting from said modification;
detecting an action linked to the modified media file and to at least one of the products or services of the vendor; and
in response to said detecting the action, updating at least one parameter of at least one of the first user account and the second user account.

2. The computer-implemented method of claim 1, wherein said associating the media file comprises embedding an identifier linking the first user account with the vendor into the media file, and wherein said associating the modified media file comprises embedding an identifier linking the second user account with the vendor into the modified media file.

3. The computer-implemented method of claim 2, wherein said embedding is carried out by encoding the identifiers into meta information of the media files such that the identifiers are invisible to a user playing back the media file.

4. The computer-implemented method of claim 2, wherein each of the identifiers is a unique character string.

5. The computer-implemented method of any preceding claim 2 to 4, wherein said embedding is carried out by encoding the identifiers into payload data of the media files.

6. The computer-implemented method of claim 5, wherein the media files are images, and wherein said embedding is carried out by encoding the identifiers into image information of the images.

7. The computer-implemented method of any preceding claim, wherein the modified media file is a replica of the media file captured via an image sensor.

8. The computer-implemented method of any preceding claim 1 to 6, wherein the modified media file is modified from a downloaded digital copy of the media file.

9. The computer-implemented method of any preceding claim, wherein said associating the media file comprises uploading, by a first client device of the first user, the media file to the server computer together with an identifier of the vendor.

10. The computer-implemented method of any preceding claim, wherein said action is a transaction and said detecting the transaction comprises receiving, from a client device of the vendor, transaction data indicating the media file, and wherein the updating is responsive to the transaction data and at least one of the information linking the first user account with the vendor and the information linking the second user account with the vendor.

11. The computer-implemented method of any preceding claim, wherein the media file contains information on the at least one of the products or services of the vendor.

12. An apparatus for a server computer, comprising:
a database configured to store a first user account of a first user and a second user account of a second user;
at least one processor configured to:
associate a media file with information linking the first user account with a vendor of products or services other than the media file,
detect modification of the media file by the second user and, in response to said detecting, associate a modified media file with information linking the second user account with the vendor, the modified media file resulting from said modification;
detect an action linked to the modified media file and to at least one of the products or services of the vendor; and
in response to said detecting the action, update at least one parameter of at least one of the first user account and the second user account.

13. A system comprising:
the apparatus of claim 11; and
at least one client device,
wherein the apparatus of claim 11 and the at least one client device comprise means for carrying out all the steps of the method according to any preceding claim 2 to 11.

14. An apparatus for a client device of a user, comprising:
a memory storing computer program applications executed in the client device;
a communication circuitry supporting at least one communication protocol;
at least one processor configured to:
receive a media file via the communication circuitry from another client device;
receive a user input to modify the media file and to modify the media file according to the user input; and
in response to modifying the media file, embed into the media file an identifier linking the user with a vendor of products or services other than the media file, the vendor associated with the media file, and upload the modified media file into the user’s user account stored in a server computer.

15. A computer program product embodied on a distribution medium readable by a computer and storing a computer program code, wherein the computer program code is configured, upon read and executed by the computer, to cause the computer to carry out a computer process comprising:
storing, in a database, a first user account of a first user and a second user account of a second user;
associating a media file with information linking the first user account with a vendor of products or services other than the media file,
detecting modification of the media file by the second user and, in response to said detecting, associating a modified media file with information linking the second user account with the vendor, the modified media file resulting from said modification;
detecting an action linked to the modified media file and to at least one of the products or services of the vendor; and
in response to said detecting the action, updating at least one parameter of at least one of the first user account and the second user account.
